(19) United States
(12) Patent Application Publication
(10) Pub. No.: US 2016/0200748 A1
(43) Pub. Date: Jul. 14, 2016

(54) FLUORINATED COMPOUNDS USABLE AS AN ORGANIC SOLVENT FOR LITHIUM SALTS

(71) Applicants: COMMISSARIAT À L'ÉNERGIE ATOMIQUE ET AUX ÉNERGIES ALTERNATIVES, Paris (FR); ECOLE NATIONALE SUPÉRIEURE DE CHIMIE DE MONTPELLIER, Montpellier Cedex 5 (FR); CENTRE NATIONAL DE LA RECHERCHE SCIENTIFIQUE, Paris (FR)

(72) Inventors: Hervé Galiano, LA VILLE AUX DAMES (FR); Stéphane Cadra, SAINT AVERTIN (FR); Nathalie Pierre, MONTS (FR); Bruno Ameduri, MONTPELLIER (FR); Ali Alaaeddine, BEYROUTH (LB)

(21) Appl. No.: 14/912,741

(22) PCT Filed: Aug. 22, 2014
(86) PCT No.: PCT/EP2014/067936

§ 371 Date: Feb. 18, 2016

(30) Foreign Application Priority Data
Aug. 23, 2013 (FR) 13 58152

(51) Int. Cl. C07F 9/40; H01M 10/052; H01M 10/0569

(52) U.S. Cl. CPC C07F 9/4006; H01M 10/0569; H01M 10/052; H01M 2300/0034

(57) ABSTRACT

The disclosure relates to compounds of following formula (I):

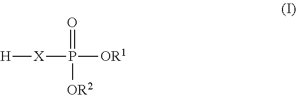

where:
X corresponds to a repeat unit of following formula (II):

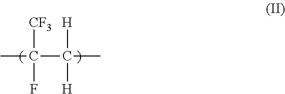

or to a sequence of said repeat units of formula (II), and
R¹ and R² are each independently an alkyl group. The disclosure further relates to the use of these compounds as organic solvents of at least one lithium salt.

### TECHNICAL FIELD

The present invention pertains to specific fluorinated compounds, to their preparation method and to use thereof as solvents capable in particular of allowing the dissolving of lithium salts.

These compounds therefore naturally find application in the field of electrolytes and especially electrolytes intended to be a constituent part of lithium batteries.

Lithium batteries are of particular interest in sectors where battery life is an essential criterion such as in the areas of computing, video, mobile telephony, transport e.g. electric vehicles, hybrid vehicles or further in the fields of medicine, space and microelectronics.

From a functional viewpoint, lithium batteries are based on the principle of lithium intercalation-deintercalation within the constituent materials of the electrodes of the battery's electrochemical cells.

More specifically, the reaction at the origin of current production (i.e. when the battery is in discharge mode) entails the transfer, via a lithium ion-conducting electrolyte, of lithium cations arriving from a negative electrode which come to be intercalated in the acceptor network of the positive electrode, whilst electrons derived from the reaction at the negative electrode will supply the external circuit to which the positive and negative electrodes are connected.

These electrolytes may be formed of a mixture comprising at least one organic solvent and at least one lithium salt to ensure the conducting of said lithium ions, which requires the lithium salt to be dissolved in said organic solvent.

At the current time the organic solvents used to ensure this function are conventionally carbonate solvents, such as ethylene carbonate, dimethyl carbonate, diethyl carbonate.

The inventors of the present invention have set out to develop novel compounds which have the following characteristics:
a capacity of easily dissolving lithium salts;
good electrochemical stability;
good thermal and chemical inertia; and
a capacity of reducing the flammability of the electrolytes in which they are incorporated.

### DISCLOSURE OF THE INVENTION

The invention is therefore directed towards fluorinated compounds of following formula (I):

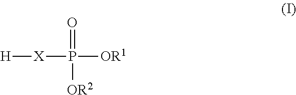

where:

*X corresponds to a repeat unit of following formula (II):

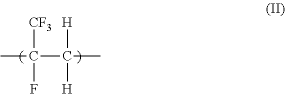

or to a sequence of said repeat unit of formula (II),
*R¹ and R² are each independently an alkyl group.

Before going into more details in the description, the following definitions are specified.

By alkyl group in the foregoing and in the remainder hereof, as is conventional, is meant a straight-chain or branched alkyl group with the formula —CₙH₂ₙ₊₁, n corresponding to the number of carbon atoms, this number possibly ranging from 1 to 5. In particular it may be a methyl group, ethyl group, n-propyl group, n-butyl group, n-pentyl group, n-hexyl group, isopropyl group, tert-butyl group and neopentyl group.

By sequence of said repeat unit of formula (II) is meant the fact that said repeat unit is repeated several times to form a group forming a bridge between the hydrogen atom and the —P(O)(OR¹) (OR²) group, said bridge-forming group therefore able to be represented by following formula (III):

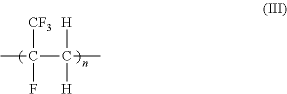

n corresponding to the number of repeats of the repeat unit between brackets, n being an integer higher than 1.

To avoid any ambiguity it is finally more explicitly specified that:
when X corresponds to a repeat unit of formula (II), the compounds of the invention can be represented by following chemical formula (IV):

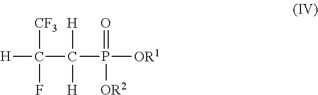

when X corresponds to a sequence of said repeat unit of formula (II), the compounds of the invention can be represented by following chemical formula (V):

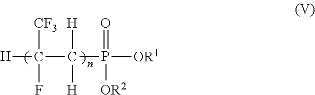

n corresponding to the number of repeats of the repeat unit between brackets, n being higher than 1, for example possibly ranging up to 10 and more specifically possibly ranging from 2 to 4.

Specific compounds conforming to the invention are those meeting following formulas (VI) and (VII):

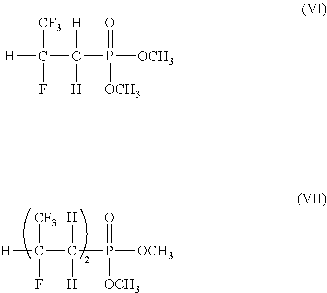

The fluorinated compounds of the invention can be prepared by implementing a method comprising a contacting step, in the presence of a free radical initiator, between a monomer of following formula (VIII):

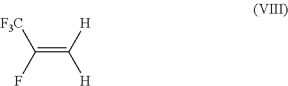

and a dialkylphosphite compound of following formula (IX):

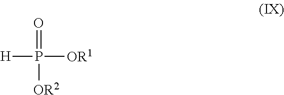

where R¹ to R² are such as defined above. The free radical initiator can be defined as a compound capable of generating free radicals when decomposing under heat. The free radicals thus formed combine with a reactive species contained in the reaction mixture such as the above-defined compound of formula (IX). This combining generates a new phosphonated radical entity which in turn associates with a new reactive species in this case here the monomer of formula (VIII). This association will generate a new radical entity which will again combine with a formula (VIII) monomer, thereby maintaining a chain reaction until exhaustion of all the reactive entities contained in the reaction mixture.

An efficient free radical initiator for this method can be selected from among peroxide derivatives such as di-tert-butylperoxide, benzoyl peroxide, tert-butyl peroxide, 2,5-di-tert-hydrogen butyldimethylperoxide.

The free radical initiator can also be selected from among persulfate derivatives, percarbonate derivatives, peroxydicarbonates.

The contacting step is preferably performed in the presence of an aprotic polar solvent capable of solubilising the different constituents of the reaction mixture; this solvent can be selected from among the following solvents:
dimethylformamide (symbolised by the abbreviation DMF);
a nitrile compound such as acetonitrile, propionitrile, butyronitrile, valeronitrile and isovaleronitrile;
a cyclic or acyclic hydrocarbon compound such as pentane, hexane, cyclohexane and heptane;
a halogenated solvent such as 1,1,2-trifluoro-1,2,2-trichloroethane, 1,1,1,3,3-pentafluorobutane, perfluorohexane, perfluoroheptane, perfluorobenzene, perfluoro-1-butyltetrahydrofuran;
a cyclic ether compound such as tetrahydrofuran (symbolised by the abbreviation THF) and 2-methyltetrahydrofuran;
a pyrrolidone compound such as N-methyl-2-pyrrolidone, N-ethylpyrrolidone;
dimethyl carbonate; and
mixtures thereof.

If the monomers used are in gaseous form and the contacting step is performed under pressure, this step can be carried out in an autoclave.

For phosphite compounds of following formula(IX), R¹ and R² may correspond to a methyl group, in which case the compound is dimethyl phosphite (also called dimethyl hydrogen phosphonate). R¹ and R² may also correspond to an ethyl group, n-propyl group, n-butyl group, n-pentyl group, n-hexyl group, isopropyl group, tert-butyl group, neopentyl group.

After the contacting step, the method may comprise a step to isolate the compound from the reaction medium, this isolating step possibly being fractionated distillation of the reaction mixture.

The compounds of the invention have special properties such as sub-ambient melt temperature (e.g. lower than 0° C.), the ability to separate ionic entities (due in particular to a dielectric constant which may be higher than 20) and chemical inertia against lithium salts.

It is therefore quite naturally that they find application as organic solvent for at least one lithium salt, this organic solvent able to be a constituent of an electrolyte comprising at least one lithium salt intended for a lithium battery.

The invention therefore also relates to:
the use of a fluorinated compound such as defined above as organic solvent of at least one lithium salt;
a composition, more specifically a liquid composition which may be a lithium ion-conducting electrolyte, comprising at least one fluorinated compound such as defined above and at least one lithium salt; and
a lithium battery comprising at least one electrochemical cell comprising an electrolyte such as defined above arranged between a positive electrode and a negative electrode.

As examples, the lithium salt can be selected from the group formed by LiPF₆, LiClO₄, LiBF₄, LiAsF₆, LiCF₃SO₃, LiN(CF₃SO₂)₃, LiN(C₂F₅SO₂), lithium bistrifluoromethylsulfonylimide (known under the abbreviation LiTFSI), LiN[SO₂CF₃]₂ and the mixtures thereof.

In the lithium battery, the above-mentioned liquid electrolyte can be caused to impregnate a separator in the electrochemical cells of lithium batteries, said separator being arranged between the positive electrode and the negative electrode of the electrochemical cell.

This separator may be in porous material such as a polymeric material capable of receiving the liquid electrolyte in its porosity.

The electrolyte is composed of at least one lithium salt and at least one organic solvent, the latter possibly being composed solely of one or more formula (I) compounds conforming to the invention or possibly also comprising at least one other aprotic solvent such as dimethyl carbonate, diethyl carbonate, ethyl and methyl carbonate, ethylene carbonate and propylene carbonate.

By positive electrode in the foregoing and in the remainder hereof, as is conventional, is meant the electrode which acts as cathode when the generator outputs current (i.e. when it is discharging) and which acts as anode when the generator is charging.

By negative electrode in the foregoing and in the remainder hereof, as is conventional, is meant the electrode which acts as anode when the generator outputs current (i.e. when it is discharging) and acts as cathode when the generator is charging.

In general, the negative electrode may be in active material which can be a carbon material such as graphite, or an oxide-type material of Li₄Ti₅O₁₂ type, said material possibly being associated with a polymer binder such as vinylidene polyfluoride, the resulting mixture possibly being deposited on a current collector in aluminium for example.

The positive electrode may be in an active material of lithiated transition metal oxide type (the metal possibly being cobalt, nickel, manganese, iron for example), said material possibly being associated with a polymer binder such as vinylidene polyfluoride, the resulting mixture possibly being deposited on a current collector in aluminium for example.

The invention is now described with reference to the following non-limiting examples given by way of indication.

### DETAILED DESCRIPTION OF PARTICULAR EMBODIMENTS

### Example 1

The following example illustrates the preparation of two fluorinated compounds conforming to the invention in accordance with the following reaction scheme:

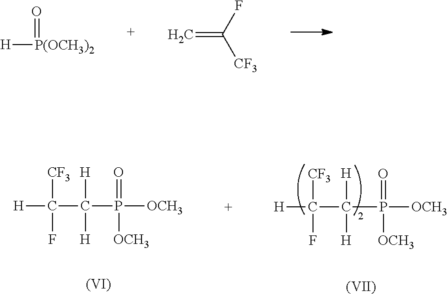

The monomer 1,1,1,2-tetrafluoroprop-2-ene is in gaseous state. On this account, the reagents were placed together in a 300 mL Parr Hastelloy autoclave equipped with a manometer, rupture disc and gas inlet and release valves. An electronic device was used to control both agitation and heating of the autoclave.

Before the reaction, the autoclave was pressurized to 30 bars nitrogen for 1 hour to check imperviousness. The autoclave was then depressurized for minutes (down to below 5 mbar) and the following reagents added:
dimethyl phosphite (86.08 g; 0.782 mol);
di-tert-butyl peroxide (0.761 g; 5.2 mmol); and
acetonitrile (80 g).

After the addition of these reagents, the autoclave was cooled to −20° C. by immersion in a mixture of acetone and liquid nitrogen, after which the 1,1,1,2-tetrafluoroprop-2-ene (30 g; 0.260 mol) was added.

The autoclave was then gradually heated up to 140° C. and pressure and temperature changes were recorded. Throughout the reaction, an increase in pressure inside the reactor was observed (up to 12 bars). The temperature reached 151° C. One hour after exothermicity, the pressure dropped to 3 bars for a temperature held at 140° C. The autoclave was then cooled (by immersion for 30 minutes in an ice bath) and degassed. On opening the autoclave the liquid residue was collected.

The crude reaction mixture was subjected to vacuum fractionated distillation (0.08 mbar) to separate the different reaction products in relation to their boiling point. The compounds having the highest molar mass have the highest boiling point. Each isolated fraction was then redistilled to yield the pure product.

The isolated products were in the form of colourless liquids. These were the monoadduct dimethyl 2,3,3,3-tetrafluoropropylphosphonate (called formula (VI) compound below) and the diadduct dimethyl 2,4,5,5,5-pentafluoro(trifluoromethyl) pentylphosphonate (called formula (VII) compound below).

The formula (VI) compound was recovered in an amount of 4.2 g (i.e. 7% yield).

It was analysed by ^{1H} NMR (CDCl₃) and ³¹P NMR (CDCl₃) respectively.

The ¹H NMR (CDCl₃) spectrum of compound 4 gave three signals:
a multiplet at position 2.0-2.5 ppm attributed to the two hydrogens of the central methylene;
a multiplet at position 3.7 ppm attributed to the six hydrogens of the two terminal methoxy groups;
a doublet of multiplets at 4.9-5.1 ppm having a coupling constant of 50 Hz and corresponding to the terminal hydrogen.

The ³¹P NMR (CDCl₃) spectrum exhibited a single signal at 25.4 ppm in the form of a triplet with a coupling constant J_{PF}=30 Hz.

The formula (VII) compound was recovered in an amount of 6 g (i.e. 13.6% yield).

It was analysed by ¹H NMR (CDCl₃) and ¹³C NMR (CDCl₃) respectively.

The ¹H NMR (CDCl₃) spectrum of compound 4 gave three signals:
a multiplet at position 2.2-2.9 ppm attributed to the four hydrogens of the two methylene groups;
a multiplet at position 3.7 ppm attributed to the six hydrogens of the two terminal methoxy groups;
a triplet of multiplets at 5.0-5.1 ppm having a coupling constant of 35 Hz and corresponding to the terminal hydrogen.

The ³¹P NMR (CDCl₃) spectrum gave a single signal at 22.3 ppm in the form of a triplet with coupling constant J_{PF}=30 Hz.

### Example 2

To assess the advantage of the compounds of the invention for electrolyte application, different physicochemical properties were determined. Their melting point (with and without LiPF₆), dielectric constants and compatibilities with the LiPF₆ salt were evaluated and are given in the following Table. By compatibility with LiPF₆ is meant that the compound of the invention must properly solubilise the lithium salt when the latter is added in a concentration of up to 1 mol/L (i.e. 1 M) and the colouring of the generated solution must not change over time i.e. it remains limpid for 24 hours at ambient temperature. It is specified that a solvent of advantage for an electrolyte must have compatibility with the conducting salt (here LiPF₆), together with a dielectric constant higher than 20 and sub-ambient melt temperature.

| | Formula (VI) | Formula (VII) |
|---|---|---|
| | compound | compound |
| Dielectric | 25.9 | 21.6 |
| constant | | |
| Melting point | <−80° C. | <−80° C. |
| LiPF₆ | Compatible | Compatible |
| compatibility | | |
| Melting point | <−80° C. | −75.3° C. |
| (1M LiPF₆) | | |

1. A compound of following formula (I): 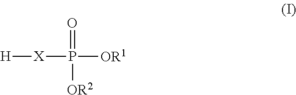
where:
X corresponds to a repeat unit of following formula (II): 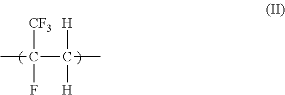
or to a sequence of said repeat unit of formula (II), and
R¹ and R² are each independently an alkyl group.

2. The compound according to claim 1 which meets following formula (V): 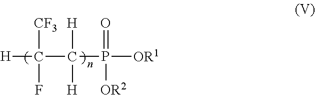
n corresponding to the number of repeats of the repeat unit between brackets, n being higher than 1.

3. The compound according to claim 2 wherein n is an integer ranging from 2 to 4.

4. The compound according to claim 1 which meets following formula (VI):

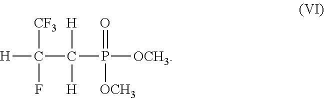 [SMILES: COP(=O)(CC(F)C(F)(F)F)OC]

5. The compound according to claim 1 which meets following formula (VII):

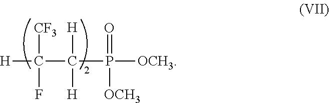

6. A method for preparing a fluorinated compound of following formula (I): 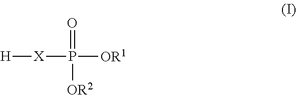
where:
X corresponds to a repeat unit of following formula (II): 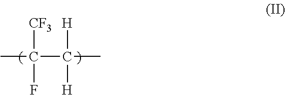
or to a sequence of said repeat unit of formula (II), and
R¹ and R² are each independently an alkyl group,
said method comprising contacting, in the presence of a free radical initiator, a monomer of following formula (VIII): 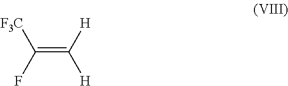
and a dialkylphosphite compound of following formula(IX):

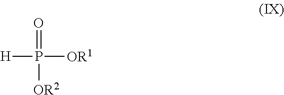

7. A method of forming a composition, comprising combining at least one lithium salt and a compound according to claim 1 as organic solvent of the at least one lithium salt.

8. A composition comprising at least one compound as defined in claim 1 and at least one lithium salt.

9. The composition according to claim 8 which is a lithium ion-conducting electrolyte.

10. A lithium battery comprising at least one electrochemical cell comprising an electrolyte as defined in claim 9 arranged between a positive electrode and a negative electrode.
